(19) United States
(12) Patent Application Publication
(10) Pub. No.: US 2014/0258021 A1
(43) Pub. Date: Sep. 11, 2014

(54) SYSTEMS AND METHODS FOR RECOMMENDATIONS BASED ON SOCIAL NETWORK ACTIVITY

(71) Applicant: Jeremiah Joseph Akin, Pleasant Hill, CA (US)

(72) Inventor: Jeremiah Joseph Akin, Pleasant Hill, CA (US)

(73) Assignee: eBay Inc., San Jose, CA (US)

(21) Appl. No.: 13/787,277

(22) Filed: Mar. 6, 2013

(51) Int. Cl. G06Q 30/06; G06Q 50/00

(52) U.S. Cl. CPC G06Q 30/0631; G06Q 50/01
USPC 705/26.7

(57) ABSTRACT

A system, computer-readable storage medium storing at least one program, and computer-implemented method for providing gift recommendations based on social network activity of the gift recipient. A gift recommendation request identifying a gift recipient is received. In response to receiving the request, coincident user data describing an activity of the gift recipient is accessed from at least one social network. At least one gift recommendation is determined based in part on the coincident user data.

### COPYRIGHT

A portion of the disclosure of this document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever. The following notice applies to the software, data, and/or screenshots which may be described below and in the drawings that form a part of this document: Copyright © 2013, eBay Incorporated. All Rights Reserved.

### TECHNICAL FIELD

Example embodiments of the present application generally relate to networked shopping and, more particularly, to a system and method for providing gift recommendations.

### BACKGROUND

Members of various social networks and other online services provide information about themselves to others online. Members of these social networks may post information that is available to the public at large or only to those other members that are allowed to view this information. This information may take the form of general information about the user, interests of the user, or information about the various tasks and activities that the user engages in.

### BRIEF DESCRIPTION OF THE DRAWINGS

Some embodiments are illustrated by way of example and not limitation in the figures of the accompanying drawings in which:

FIG. 1 is a network diagram depicting a network system having a client-server architecture configured for exchanging data over a network, according to an example embodiment.

FIG. 2 is a block diagram illustrating an example embodiment of multiple market place applications, which are provided as part of the network based marketplace.

FIG. 3 is a block diagram illustrating an example embodiment of multiple recommendation applications, which are provided as part of the network based marketplace.

FIG. 4 is a flowchart illustrating an example method for providing a gift recommendation, according to an example embodiment.

FIG. 5 is a flowchart illustrating an example method for obtaining coincident user data, according to an example embodiment.

FIG. 6A is an interface diagram illustrating an example gift recommendation request, according to some embodiments.

FIG. 6B is an interface diagram illustrating an example gift recommendation request based on recommendation criteria, according to some embodiments.

FIG. 6C is an interface diagram illustrating an example gift recommendation, according to some embodiments.

FIG. 7 is a block diagram illustrating a mobile device, according to an example embodiment.

FIG. 8 is a diagrammatic representation of a machine in the example form of a computer system within which a set of instructions for causing the machine to perform any one or more of the methodologies discussed herein may be executed.

### DETAILED DESCRIPTION

Reference will now be made in detail to specific example embodiments for carrying out the inventive subject matter. Examples of these specific embodiments are illustrated in the accompanying drawings. It will be understood that it is not intended to limit the scope of the claims to the described embodiments. On the contrary, it is intended to cover alternatives, modifications, and equivalents as may be included within the spirit and scope of the disclosure as defined by the appended claims. In the following description, specific details are set forth in order to provide a thorough understanding of the subject matter. Embodiments may be practiced without some or all of these specific details. In addition, well known features may not have been described in detail to avoid unnecessarily obscuring the subject matter.

In accordance with the present disclosure, components, process steps, and/or data structures may be implemented using various types of operating systems, programming languages, computing platforms, computer programs, and/or general purpose machines. In addition, those of ordinary skill in the art will recognize that devices of a less general purpose or nature, such as hardwired devices, field programmable gate arrays (FPGAs), application specific integrated circuits (ASICs), or the like, may also be used without departing from the scope and spirit of the concepts disclosed herein. Embodiments may also be tangibly embodied as a set of computer instructions stored on a computer readable medium, such as a memory device.

Aspects of the present disclosure describe systems and methods for providing gift recommendations for a gift recipient based on social network activity. In some embodiments, the recommendation may be based on coincident user data of the gift recipient. Coincident data is data obtained from a social network describing an activity of the gift recipient. The coincident data may be collected as the activity is occurring. For example, coincident data may include a check-in by the gift recipient posted to the social network profile of the gift recipient while the gift recipient is present at the location or attending the event for which the check-in was created. In some instances, the coincident data is collected before an activity occurs, such as an acceptance of an invitation to an event including the activity. In other instances, coincident data is collected within a predetermined time after the user has participated in the activity. Coincident data may be publically available data that is available to users of the social network. Coincident data may only be available to a user based on the user being connected to the gift recipient on the social network.

In some embodiments, the gift recommendation may be based on a combination of coincident data and demographic data of the gift recipient. Demographic data may be any known data about the gift recipient which describes a characteristic of the user. For example, demographic data may include the gender and age of the gift recipient.

Consistent with some embodiments, a user may be provided an option to specify a set of criteria for the requested gift recommendation. For example, a user may be able to specify a price range for the requested gift recommendation.

Consistent with some embodiments, the information used in determining a gift recommendation may be filtered to provide the most relevant recommendations for the gift recipient.

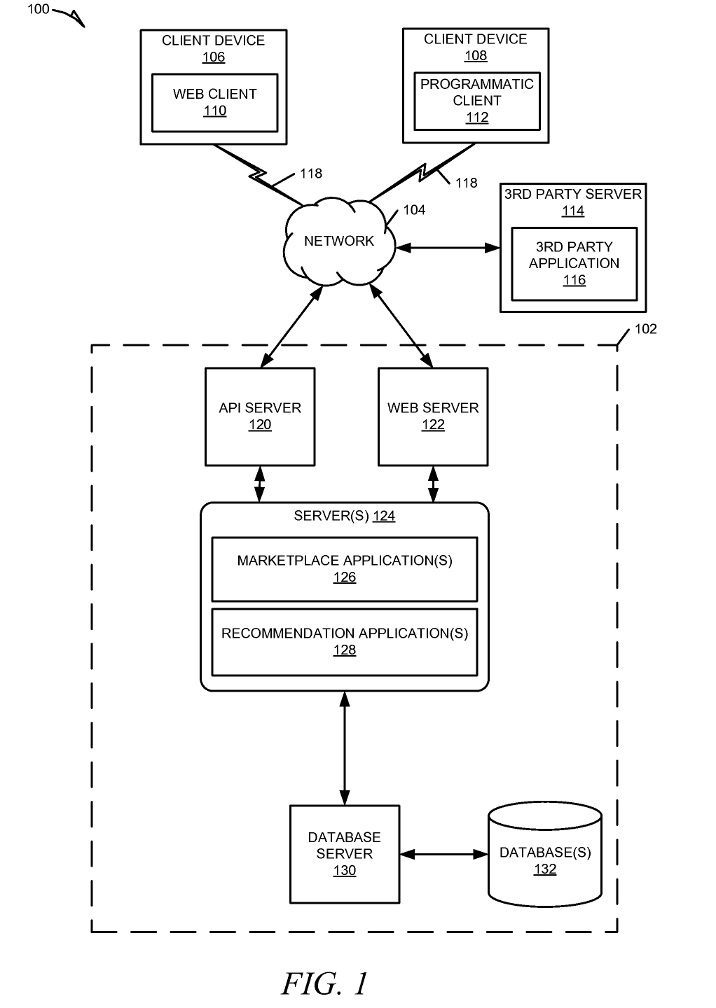

FIG. 1 is a network diagram depicting an example network system 100, according to one embodiment, having a client-server architecture configured for exchanging data over a network. For example, the network system 100 may be a network-based marketplace 102 where clients may communicate and exchange data within the network system 100. The data may pertain to various functions and aspects associated with the network system 100 and its users.

A data exchange platform, in an example form of a network-based marketplace 102, may provide server-side functionality, via a network 104 (e.g., the Internet), to one or more client devices. The one or more client devices may be operated by users that use the network system 100 and more specifically, the network-based marketplace 102, to exchange data over the network 104. These transactions may include transmitting, receiving (communicating), and processing data to, from, and regarding content and users of the network system 100. The data may include, but are not limited to, user preferences; coincident user data; demographic user data; product and service feedback, advice, and reviews; product, service, manufacture, and vendor recommendations and identifiers; product and service listings associated with buyers and sellers; product and service advertisements; auction bids; transaction data; and other data.

In various embodiments, the data exchanges within the network system 100 may be dependent upon user-selected functions available through one or more client or user interfaces (UIs). The UIs may be associated with a client device, such as a client device 106 using web client 110. The web client 110 may be in communication with the network-based marketplace 102 via a web server 122. The UIs may also be associated with a client device 108 using a programmatic client 112, such as a client application, or a third party server 114 (e.g., one or more servers or client devices) hosting a third party application 116. It can be appreciated that, in various embodiments, the client device 106, 108, and/or the third party server 114 may be associated with a buyer, a seller, a third party electronic commerce platform, a payment service provider, or a shipping service provider, each in communication with the network-based marketplace 102 and optionally each other. The buyers and sellers may be any one of individuals, merchants, or service providers, among other things.

The client devices 106 and 108 may be any of a variety of types of devices (e.g., a cellular telephone, a personal digital assistant (PDA), a personal navigation device (PND), a handheld computer, a tablet computer, a desktop computer, a notebook computer, a wearable computing device, or other type of movable device). The client devices 106 and 108 may interface via a connection 118 with a communication network 104 (e.g., the Internet or WAN). Depending on the form of the client device 106 and 108, any of a variety of types of connections 118 and communication networks 104 may be used.

For example, the connection 118 may be Code Division Multiple Access (CDMA) connection, a Global System for Mobile communications (GSM) connection, or other type of cellular connection. Such connection 118 may implement any of a variety of types of data transfer technology, such as Single Carrier Radio Transmission Technology (1xRTT), Evolution-Data Optimized (EVDO) technology, General Packet Radio Service (GPRS) technology, Enhanced Data rates for GSM Evolution (EDGE) technology, or other data transfer technology (e.g., fourth generation wireless, 4G networks). When such technology is employed, the communication network 104 may include a cellular network that has a plurality of cell sites of overlapping geographic coverage, interconnected by cellular telephone exchanges. These cellular telephone exchanges may be coupled to a network backbone (e.g., the public switched telephone network (PSTN), a packet-switched data network, or to other types of networks).

In another example, the connection 118 may be Wireless Fidelity (Wi-Fi, IEEE 802.11x type) connection, a Worldwide Interoperability for Microwave Access (WiMAX) connection, or another type of wireless data connection. In such an embodiment, the communication network 104 may include one or more wireless access points coupled to a local area network (LAN), a wide area network (WAN), the Internet, or other packet-switched data network.

In yet another example, the connection 118 may be a wired connection, for example an Ethernet link, and the communication network 104 may be a LAN, a WAN, the Internet, or other packet-switched data network. Accordingly, a variety of different configurations are expressly contemplated.

Turning specifically to the networked-based marketplace 102, an application programming interface (API) server 120 and a web server 122 are coupled to, and provide programmatic and web interfaces respectively to, one or more application servers 124. The application servers 124 host one or more marketplace application(s) 126, and recommendation application(s) 128. The application servers 124 may be coupled via these interfaces to the communication network 104, for example, via wired or wireless interfaces. The application servers 124 are, in turn, shown to be coupled to one or more database server(s) 130 that facilitate access to one or more database(s) 132. In some examples, the application servers 124 can access the database(s) 132 directly without the need for a database server 130.

The marketplace applications 126 may provide a number of marketplace functions and services (e.g., listing, payments, etc.) to users that access the network-based marketplace 102. The recommendation applications 128 may provide gift recommendation services and functions to users. The recommendation applications 128 may receive gift recommendation requests, which may include information identifying the gift recipient and may include one or more recommendation criteria. The recommendation applications 128 may, in turn, provide a gift recommendation for the gift recipient including one or more items or services offered for sale.

While the recommendation applications 128 and marketplace applications 126 are shown in FIG. 1 to both form part of the network-based marketplace 102, it will be appreciated that in alternative embodiments, the recommendation modules 128 may form part of a social networking service that is separate and distinct from the marketplace 102.

Database server 130 may facilitate access to one or more databases 132 and retrieve data for inclusion in the network-based marketplace 102. The data may correspond to user data, transaction history, listings of products or related products offered for sale, feedback for products, and so forth. In some embodiments, the databases 132 may include databases both internal and external to the network-based marketplace 102.

Further, while the system 100 shown in FIG. 1 employs a client-server architecture, the present invention is, of course, not limited to such an architecture, and could equally well find application in an event-driven, distributed, or peer-to-peer architecture system, for example. The various modules of the application servers 124 may also be implemented as standalone systems or software programs, which do not necessarily have networking capabilities.

FIG. 1 also illustrates a third party application 116 that may execute on a third party server 114 and may have programmatic access to the network-based marketplace 102 via a programmatic interface provided by the API server 120. For example, the third party application 116 may use information retrieved from the network-based marketplace 102 to support one or more features or functions on a website hosted by the third party. The third party website may, for example, provide one or more networking, marketplace, or payment functions that are supported by the relevant applications of the network-based marketplace 102.

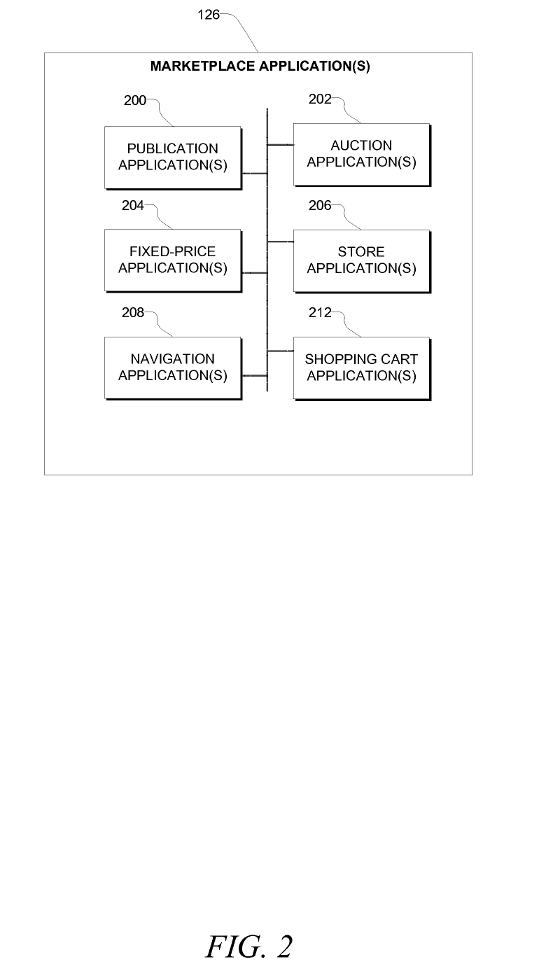

FIG. 2 is a block diagram illustrating an example embodiment of multiple marketplace applications 126, which are provided as part of the network-based marketplace 102. The marketplace applications 126 may be hosted on dedicated or shared server machines (not shown) that are communicatively coupled to enable communications between server machines. Each of the marketplace applications 126, themselves, are communicatively coupled (e.g., via appropriate interfaces) to each other and to various data sources, so as to allow information to be passed between marketplace applications 126 or so as to allow the marketplace applications 126 to share and access common data. The marketplace applications 126 may furthermore access one or more databases 132 via the database servers 130.

The marketplace applications 126 may provide a number of publishing, listing, and price-setting mechanisms whereby a seller may list (or publish information concerning) goods or services for sale, a buyer can express interest in or indicate a desire to purchase such goods or services, and a price can be set for a transaction pertaining to the goods or services. To this end, the marketplace applications 126 are shown to include at least one publication application 200 and one or more auction applications 202 which support auction-format listing and price setting mechanisms (e.g., English, Dutch, Vickrey, Chinese, Double, Reverse auctions etc.). The various auction applications 202 may also provide a number of features in support of such auction-format listings, such as a reserve price feature whereby a seller may specify a reserve price in connection with a listing and a proxy-bidding feature whereby a bidder may invoke automated proxy bidding.

A number of fixed-price applications 204 support fixed-price listing formats (e.g., the traditional classified advertisement-type listing or a catalogue listing) and buyout-type listings. Specifically, buyout-type listings (e.g., including the Buy-It-Now (BIN) technology developed by eBay Inc., of San Jose, Calif.) may be offered in conjunction with auction-format listings, and allow a buyer to purchase goods or services, which are also being offered for sale via an auction, for a fixed-price that is typically higher than the starting price of the auction.

Store applications 206 may allow sellers to group their item listings (e.g., goods and/or services) within a “virtual” store, which may be branded and otherwise personalized by and for the sellers. Such a virtual store may also offer promotions, incentives, and features that are specific and personalized to a relevant seller. In one embodiment, the listings and/or transactions associated with the virtual store and its features may be provided to one or more users.

Navigation of the network-based marketplace 102 may be facilitated by one or more navigation applications 208. For example, a search application may, inter alia, enable key word searches of listings published via the marketplace 102. A browser application may allow users via an associated user interface to browse various category, catalogue, inventory, social network, and review data structures within the marketplace 102. Various other navigation applications (e.g., an external search engine) may be provided to supplement the search and browsing applications.

In one embodiment, the electronic shopping cart application(s) 212 are used to create an electronic shopping cart used by users of the network-based marketplace 102 to add and store items listed by the store application(s) 208. The electronic shopping cart applications may also be used to “check out,” meaning a user may purchase items in the electronic shopping cart. The electronic shopping cart applications 212 may facilitate the transactions by automatically finding the items in the electronic shopping cart across at least one or all of a predefined set of vendors, a comparison shopping site, an auction site, etc. In various embodiments, the selection criteria for which vendor or vendors to purchase from may include, but is not limited to, criteria such as lowest cost, fastest shipping time, preferred or highest rated vendors or sellers, or any combination thereof.

It will be appreciated that one or more the various example marketplace applications 126 may be combined into a single application. Further, in some embodiments, one or more applications may be omitted and additional applications may also be included. Additionally, while the applications of FIG. 2 are discussed in the plural sense, it is noted that a single version of the application may be utilized.

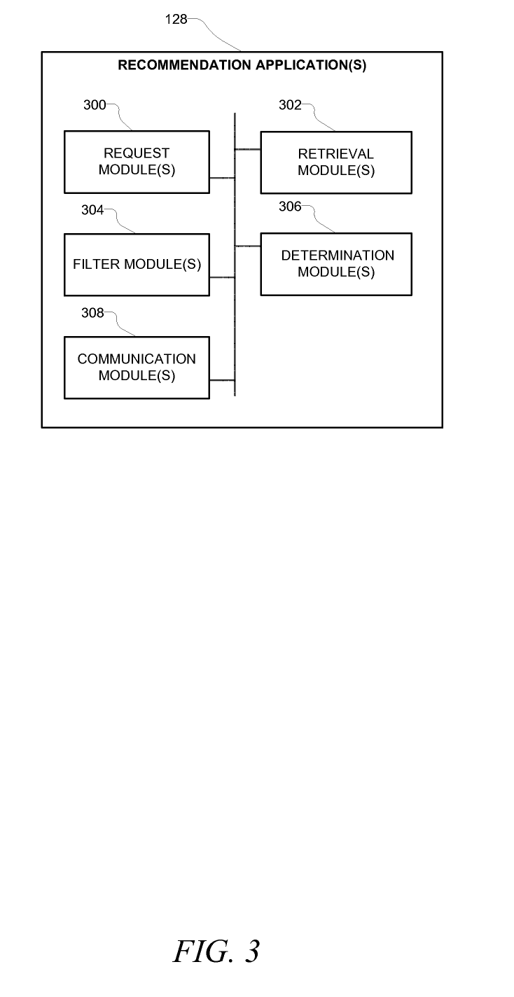

FIG. 3 is a block diagram illustrating an example embodiment of multiple modules forming the recommendation applications 128, which are provided as part of the network-based marketplace 102. Each of the modules of the recommendation applications 128 may be hosted on dedicated or shared server machines (not shown) that are communicatively coupled to enable communications between server machines. Each of the modules of the recommendation applications 128, themselves, are communicatively coupled (e.g., via appropriate interfaces) to each other and to various data sources, so as to allow information to be passed between each of the modules and each recommendation applications 128 or so as to allow the modules of the recommendation applications 128 to share and access common data. The modules of the recommendation applications 128 may furthermore access one or more databases 132 via the database servers 130.

The recommendation applications 128 may provide a number of gift recommendation services to users. To this end, the recommendation applications 128 are illustrated to include one or more request modules 300 which may receive a gift recommendation request for a particular gift recipient. The gift recommendation request may identify the gift recipient by name and, in some embodiments, may include an additional identifier of the gift recipient. The additional identifier may, for example, include an email address, a phone number, a username or a social network profile identifier. In some embodiments, the social network profile identifier may include a uniform resource locator (URL) corresponding to the social network profile of the gift recipient. In some embodiments, the social network profile identifier may be another type of unique identifier (e.g., a TWITTER “handle”) that may assist the recommendation applications 128 in identifying the gift recipient or a social network profile belonging to the gift recipient.

The gift recommendation request may also include one or more recommendation criteria. The recommendation criteria may be used to narrow down the number of items or services returned as part of the gift recommendation. The recommendation criteria may, for example, include a price or price range, an expected delivery date or date range, a category of item or service, a clothing size, a shoe size, a parcel carrier preference, a gift occasion type, a relationship of the requesting user to the gift recipient or a location or region from which the item is to be shipped or service rendered.

In some embodiments, the request modules 300 may receive a gift recommendation request from a requesting user operating a client device (e.g., client 106) via a GIU. In some embodiments, the gift recommendation request may be received by the request module 300 from a third party server (e.g., third party server 114) as a part of a social networking service offered by the third party.

As illustrated in FIG. 3, the recommendation applications 128 may include one or more retrieval modules 302 which may retrieve user data corresponding to the gift recipient from one or more social networks. In some embodiments, the user data may include demographic data corresponding to the gift recipient. Demographic data may include information describing a characteristic of the gift recipient. Demographic data may, for example, include gender, age, location information, employment history, education history, contact information, familial relations, or user interests.

In some embodiments, the user data may include coincident data corresponding to the gift recipient. Coincident data may include information describing an activity of the gift recipient that is collected as the activity is occurring. Coincident data may, for example, include check-ins, status updates, wall posts, or tweets.

For purposes of the present disclosure, a “check-in” refers to a service provided by a social network that allows users to “check-in” to a physical space and share their location with other users of the social network. In some embodiments, a user may check-in to a specific location by sending a text message to the relevant social network service. Consistent with some embodiments, users may check-in to a specific location by using a mobile application provided by the social network on a client device (e.g., client device 106). The social network mobile application may use the GPS functionality of the client device to find the current location of the user and allow the user to share this information with other users of the social network.

The retrieval module 302 may use the information identifying the gift recipient included in the gift recommendation request (e.g., the gift recipient's name and email address) to retrieve user data corresponding to the gift recipient that has been made publically available by the gift recipient. For example, the retrieval module 302 may use the name and email address of the gift recipient to locate a Facebook profile corresponding to the gift recipient. In this example, the retrieval module 302 may obtain all user data that the gift recipient has made publically available by virtue of the gift recipient's privacy settings.

In some embodiments, the retrieval module 302 may use the information identifying the gift recipient included in the gift recommendation request in conjunction with a user's login information to obtain user data of the gift recipient. Login information refers to the credentials required to access the social network profile of the user. Login credentials may include a username, password, and in some embodiments, a PKI certificate. Consistent with this embodiment, the retrieval module 302 may use the login information of the user to obtain, via an API, user data of the gift recipient that has been made available to the user by virtue of the user being connected to the gift recipient on the social network.

For purposes of the present disclosure, being “connected” on a social network, also referred to as a social network “connection,” may include both a bi-lateral agreement between members of the social network as well as situations in which there is only a unilateral acknowledgement of the “connection.” In the bi-lateral agreement situation both members of the “connection” acknowledge the establishment of the connection (e.g., friends). Similarly, in the unilateral acknowledgement situation, a member may elect to “follow” or “watch” another member. In contrast to bi-lateral agreement, the concept of “following” another member typically is a unilateral operation because it may not require acknowledgement or approval by the member that is being followed.

As illustrated in FIG. 3, the recommendation applications 128 may include one or more filter applications 304, which may filter data used to make a gift recommendation. In some embodiments, the data used to make a gift recommendation is the user data retrieved by the one or more retrieval applications 302. The filter modules 304 may filter the data used in making a gift recommendation based on the type of data. For example, the filter module 304 may filter user data so that only check-ins of the gift recipient are used in determining the gift recommendation.

In some embodiments, the filter modules 304 may filter data used in making a recommendation based on a time, location, region, or category associated with the data. For example, the filter module 304 may filter data used in making a gift recommendation so as to omit coincident user data that was collected before a certain time. In another example, the filter module 304 may filter user data used in making the gift recommendation so as to only include check-ins of the gift recipient at a certain category of events (e.g., concerts). In yet another example, the filter module 304 may filter data to omit data collected outside a certain distance range from the gift recipient's current location.

In some embodiments, the filter modules 304 may filter data used in making the gift recommendation based on the relationship between the potential gift giver and the intended gift recipient. For example, a young child may request a gift recommendation for his or her father. In this example, the filter module 304 may filter out the father's check-in to several local bars so that such information is not used in making a recommendation that would be inappropriate for the child to purchase for the father.

In some embodiments, the filter module 304 may filter the user data based on criteria supplied by a user. For example, the filter module 304 may filter user data so that only user data collected during a particular time range specified by the user is used in determining the gift recommendation for the gift recipient.

Consistent with some embodiments, the filter modules 304 may also filter the items or services included in a gift recommendation based on the techniques described herein in reference to the filtering of data used in making a gift recommendation.

As illustrated in FIG. 3, the recommendation applications 128 may include one or more determination modules 306, which may determine one or more gift recommendations for the gift recipient. The one or more gift recommendations may include an item or service offered for sale. In some embodiments, the determination modules 306 determine the gift recommendations based on the coincident user data of the gift recipient retrieved by the retrieval module 300. In some embodiments, the determination modules 306 may determine the gift recommendations based on the demographic and coincident user data of the gift recipient retrieved by the retrieval module 300.

In some embodiments, the determination of the one or more gift recommendations may include identifying one or more keywords from the coincident data. The determination modules 306 may then use the identified keywords to match items or services offered for sale that are similar to or include the one or more keywords. For example, the coincident data of the gift recipient retrieved by the retrieval modules 302 may include a check-in to the “Great American Beer Festival.” In this example, the determination module 306 may identify “beer” as a keyword from the check-in. Using “beer” as a keyword, the determination module 306 may identify a number of beers to be included in the gift recommendation.

In some embodiments, the determination module 306 may also identify a number of items or services related to each identified keyword. Following the “beer” example from above, the determination module 306 may identify a beer mug, a beer bottle opener, and a mini beer fridge to be included in the gift recommendation.

In some embodiments, the determination module 306 may determine gift recommendations based on the number and frequency of certain data appearing in the coincident data. For example, the determination module 306 may recommend a gift card for a particular restaurant for which the gift recipient checks-in to on a weekly basis.

In some embodiments, the determination modules 306 may include the intelligence to learn from previous gift recommendations that were used by previous users to purchase items or services recommended therein. The determination module 306 may determine that users receiving a gift recommendation based on a certain type of coincident data of the gift recipient most often purchase a particular item or service. In future recommendations, the determination module 306 may recommend the most often purchased item or service corresponding to that type of coincident data. To this end, the determination module 306 may track and store transactions resulting from a previously supplied gift recommendation in a database (e.g., database 132) for later retrieval.

Consistent with some embodiments, the determination module 306 may work in conjunction with the filter module 304 to narrow results provided in a gift recommendation to only those meeting the recommendation criteria set forth in the gift recommendation request received by the request module 300.

As illustrated in FIG. 3, the recommendation applications 128 may include one or more communication modules 308, which may communicate the gift recommendations determined by the determination module 306 to the applicable requesting user or service.

In some embodiments, the communication module 308 may be used for generation and delivery of messages including the recommendation to users of the network-based marketplace 102. Respective communication modules 308 may utilize any one of a number of message delivery networks and platforms to deliver messages to users. For example, the communication modules 308 may deliver electronic mail (e-mail), instant message (IM), Short Message Service (SMS), text, facsimile, or voice (e.g., Voice over IP (VoIP)) messages via the wired (e.g., the Internet), plain old telephone service (POTS), or wireless (e.g., mobile, cellular, WiFi, WiMAX) networks.

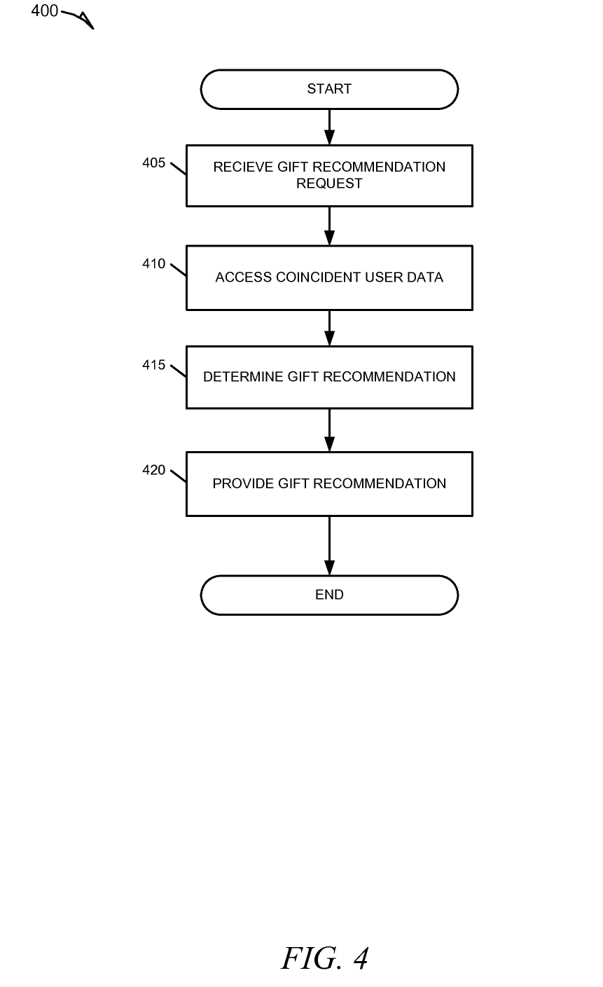

FIG. 4 is a flowchart illustrating an example method 400 for providing a gift recommendation for a gift recipient, according to an example embodiment. In this example, the method 400 may include operations such as receiving a gift recommendation request 405, accessing coincident user data 410, determining gift recommendation 415, and providing a user with the gift recommendation 420.

At operation 405, a gift recommendation request is received by the request modules 300. The gift recommendation may identify the gift recipient by name and, in some embodiments, with an additional identifier. In some embodiments, the gift recommendation request may also include one or more gift recommendation criteria.

In some embodiments, the gift recommendation request may be received by the request module 300 directly from a user using a client device (e.g., client device 106) via a graphical user interface. In some embodiments, the gift recommendation request may be received from a third party server 114, via an API, as a part of a social network service provided by the third party.

At operation 410, the retrieval module 302 may retrieve coincident user data of the gift recipient from one or more social networks. The coincident user data includes data that describes an event and is collected by the social networking while the event is occurring. For example, the coincident user data may include a location check-in.

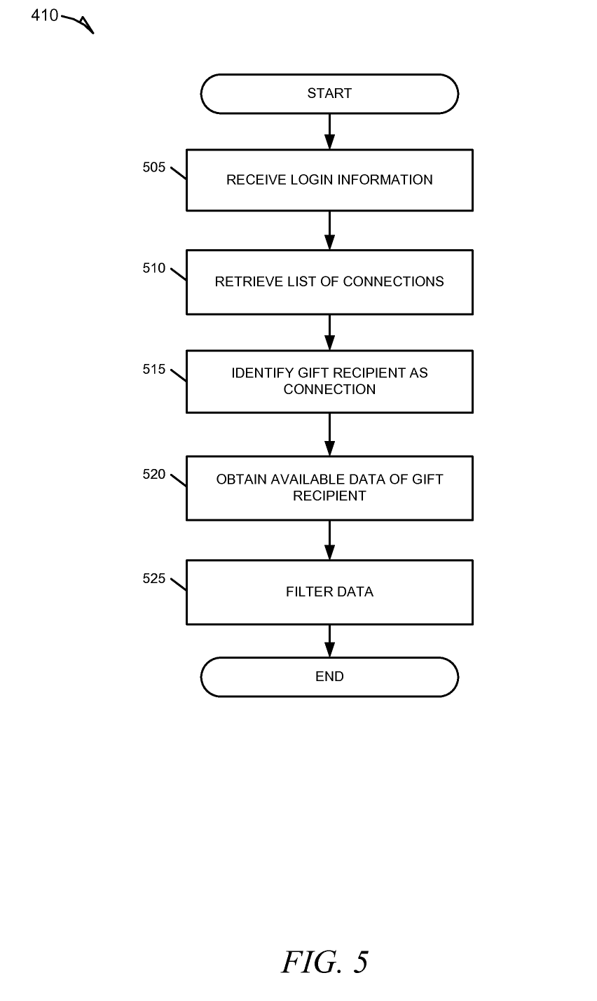

In some embodiments, the retrieval module 302 may also retrieve demographic data of the gift recipient at operation 410. Further details of operations comprising operation 410 are described below in reference to FIG. 5, according to one embodiment.

At operation 415, the determination module 306 may determine at least one gift recommendation based on the coincident user data. The gift recommendation may include an item or service offered for sale. In some embodiments, the determination of the at least one gift recommendation is based on identifying one or more keywords from the coincident user data. The one or more identified keywords may then be used by the determination module 306 to identify similar or matching items or services related to the identified keywords.

In some embodiments, the at least one gift recommendations may also be based on one or more recommendation criteria supplied by a user with the gift recommendation request. In some embodiments, the at least one gift recommendation may also be based on demographic data of the gift recipient.

Method 400 may also include communicating the at least one gift recommendation at operation 420. In some embodiments, the at least one gift recommendation may be communicated to the user requesting the gift recommendation. The communicating of the at least one gift recommendation may include providing the user with an option to purchase at least one gift recommendation and facilitating the purchase of the at least one gift recommendation.

FIG. 5 is a flowchart illustrating an example embodiment of operation 410 for retrieving coincident user data corresponding to the gift recipient, according to an example embodiment. In this example, the operation 410 may include operations such as receiving login information of the requesting user at 505, retrieving a list of connections at 510, identifying the gift recipient from the list of connections at 515, obtaining available data at 520, and filtering data at 525.

At operation 505, the login information for one or more social networks of the user requesting the gift recommendation is received. In some embodiments, the login information may be received by the request module 300 as part of the gift recommendation request. In other embodiments, the login information may be received by the retrieval module 302 as a separate communication. The login information may include any information necessary to gain access to the social network profile of the requesting user such as a username and password.

At operation 510, the retrieval module 302 may use the received login information to retrieve, via an API, a list of all the connections of the requesting user.

At operation 515, the retrieval module 302 may search the list of connections of the requesting users to locate the gift recipient identified in the gift recommendation request received by the request modules 300 at operation 405. If the gift recipient is not identified from in the list of connections of the requesting user, the retrieval module 302 may utilize an additional identifier of the gift recipient included in the gift recommendation request to locate at least one social network profile of the gift recipient. At operation 520, the retrieval modules 302 may obtain user data (e.g., coincident user data) of the gift recipient that has been made publically available to anyone viewing the profile of the gift recipient.

If, at operation 515, the gift recipient is identified in the list of connections of the requesting user, the retrieval modules 302 may obtain user data (e.g., coincident user data) of the gift recipient that has been made available to the requesting user based on the connection with the gift recipient.

At operation 525, the retrieved user data is filtered by the filter module 308. In some embodiments, the user data may be filtered based on demographic information of the gift recipient. In some embodiments, the user data may be filtered based on demographic information of the requesting user. In some embodiments, the user data may be filtered based on the relationship between the requesting user and the gift recipient. In some embodiments, the user data may be filtered based on criteria supplied by the gift recipient.

### Example User Interface

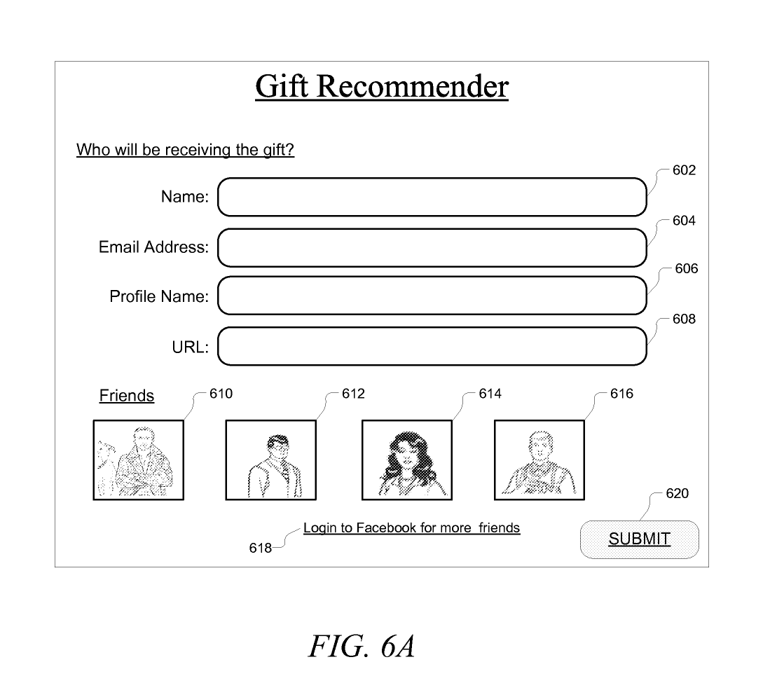

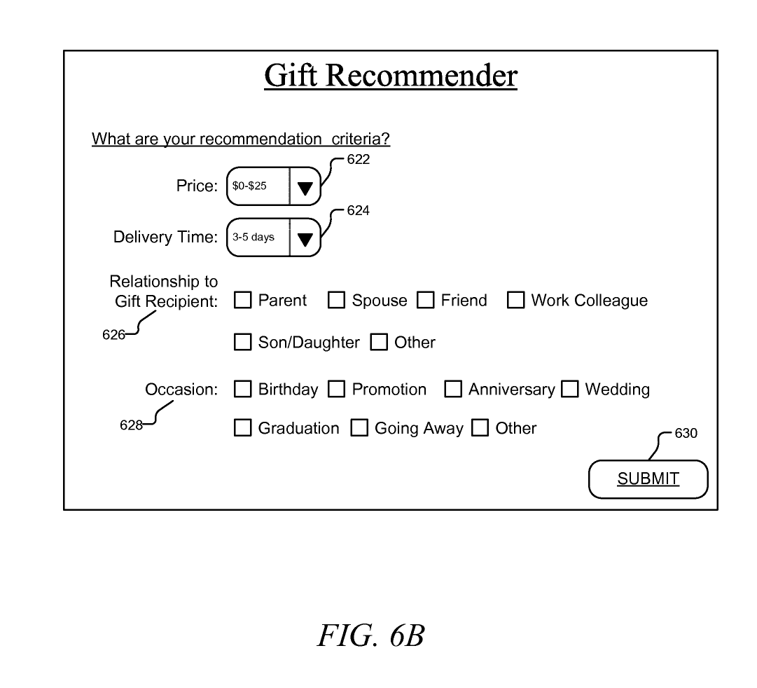

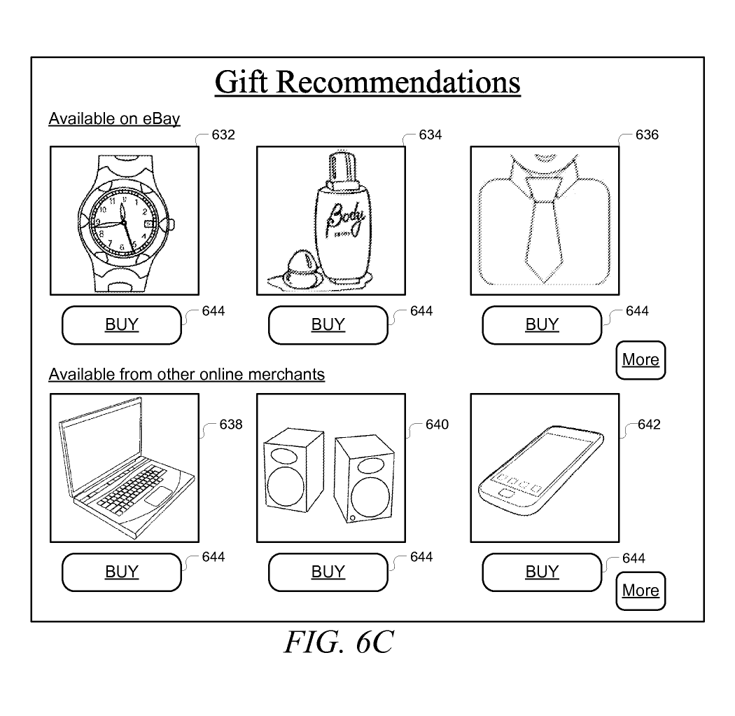

FIG. 6A is an interface diagram illustrating a portion of an example gift recommendation request, according to some embodiments. The displayed gift recommendation request may be viewed by a user on a user interface of a client device (e.g., client device 106) and transmitted to the recommendation applications 128. The gift recommendation request may include field 602 to identify the intended gift recipient by name. In some embodiments, the gift recommendation request may also include fields 604-608, which may provide additional identifiers to the recommendation applications 128 used to locate at least one social network profile corresponding to the gift recipient.

In some embodiments, the gift recommendation request may include selections 610-616, which may provide the user the ability to select one of a plurality of social network connections of the user as the intended gift recipient. In some embodiments, the gift recommendation request may also include prompt 618 to allow a user to provide login information for one or more social network profiles of the user.

As illustrated in FIG. 6A, the gift recommendation request may also include button 620. Upon selecting button 620 the gift recommendation request may be communicated to the request module 300.

FIG. 6B is an interface diagram illustrating an example gift recommendation request based on recommendation criteria, according to some embodiments. In some embodiments, the user may be presented with the option to include the recommendation criteria illustrated in FIG. 6B upon selection of button 620 (presented in FIG. 6A).

As illustrated in FIG. 6B, the gift recommendation request may further include criteria selections 622-628. The information supplied in each of the selections 622-628 may be used according to techniques described herein to filter gift recommendations generated by the recommendation applications 128.

As illustrated in FIG. 6B, the gift recommendation request may also include button 630. Upon selecting button 630 the gift recommendation criteria may be communicated to the request module 300.

FIG. 6C is an interface diagram illustrating an example gift recommendation, according to some embodiments. As illustrated in FIG. 6C, a gift recommendation may include several items 632-642 offered for sale by one or more merchants. As illustrated in FIG. 6C, each of the items comprising the gift recommendation may include a button 644, which may provide the user the option to purchase the corresponding item. Upon selection of button 644, the purchase of the corresponding item may be facilitated by the marketplace applications 126 or by a similar online marketplace hosted by a third party server (e.g., third party server 114).

### Example Client Device

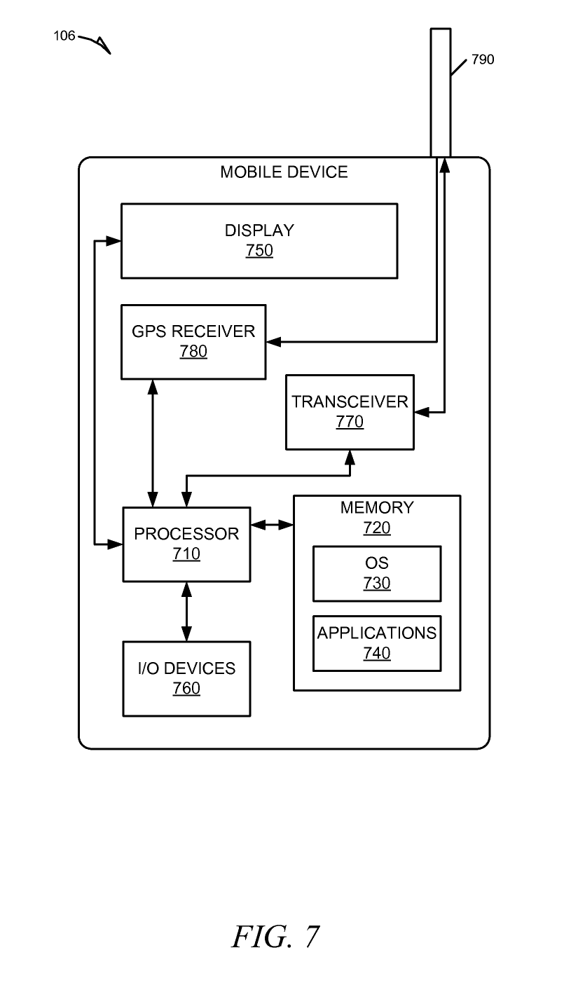

FIG. 7 is a block diagram illustrating a client device 106, such as a mobile device, according to an example embodiment. The client device 106 may include a processor 710. The processor 710 may be any of a variety of different types of commercially available processors suitable for mobile devices (e.g., an XScale architecture microprocessor, a Microprocessor without Interlocked Pipeline Stages (MIPS) architecture processor, or another type of processor). A memory 720, such as a Random Access Memory (RAM), a Flash memory, or other type of memory, is typically accessible to the processor 710. The memory 720 may be adapted to store an operating system (OS) 730, as well as application programs 740, such as a mobile location enabled application that may provide location based services (e.g., physical location check-in) to a user. The processor 710 may be coupled, either directly or via appropriate intermediary hardware, to a display 750 and to one or more input/output (I/O) devices 760, such as a keypad, a touch panel sensor, a microphone, and the like. Similarly, in some embodiments, the processor 710 may be coupled to a transceiver 770 that interfaces with an antenna 790. The transceiver 770 may be configured to both transmit and receive cellular network signals, wireless data signals, or other types of signals via the antenna 790, depending on the nature of the mobile device 106. In this manner, the connection 118 with the network 104 may be established. Further, in some configurations, a GPS receiver 780 may also make use of the antenna 790 to receive GPS signals

### Modules, Components and Logic

Certain embodiments are described herein as including logic or a number of components, modules, or mechanisms. Modules may constitute either software modules (e.g., code embodied on a machine-readable medium or in a transmission signal) or hardware modules. A hardware module is a tangible unit capable of performing certain operations and may be configured or arranged in a certain manner. In example embodiments, one or more computer systems (e.g., a standalone, client or server computer system) or one or more hardware modules of a computer system (e.g., a processor 710 or a group of processors 710) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor 710) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired) or temporarily configured (e.g., programmed) to operate in a certain manner and/or to perform certain operations described herein. Considering embodiments in which hardware modules are temporarily configured (e.g., programmed), each of the hardware modules need not be configured or instantiated at any one instance in time. For example, where the hardware modules comprise a general-purpose processor 710 configured using software, the general-purpose processor 710 may be configured as respective different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses that connect the hardware modules). In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors 710 that are temporarily configured (e.g., by software) or permanently configured to perform the relevant operations. Whether temporarily or permanently configured, such processors 710 may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or more processors 710 or processor-implemented modules. The performance of certain of the operations may be distributed among the one or more processors 710, not only residing within a single machine, but deployed across a number of machines. In some example embodiments, the processor or processors 710 may be located in a single location (e.g., within a home environment, an office environment or as a server farm), while in other embodiments the processors 710 may be distributed across a number of locations.

The one or more processors 710 may also operate to support performance of the relevant operations in a “cloud computing” environment or as a “software as a service” (SaaS). For example, at least some of the operations may be performed by a group of computers (as examples of machines including processors 710), with these operations being accessible via a network (e.g., the Internet) and via one or more appropriate interfaces (e.g., APIs).

### Electronic Apparatus and System

Example embodiments may be implemented in digital electronic circuitry, or in computer hardware, firmware, software, or in combinations of them. Example embodiments may be implemented using a computer program product, for example, a computer program tangibly embodied in an information carrier, for example, in a machine-readable medium for execution by, or to control the operation of, data processing apparatus, for example, a programmable processor 710, a computer, or multiple computers.

A computer program can be written in any form of programming language, including compiled or interpreted languages, and it can be deployed in any form, including as a stand-alone program or as a module, subroutine, or other unit suitable for use in a computing environment. A computer program can be deployed to be executed on one computer or on multiple computers at one site or distributed across multiple sites and interconnected by a communication network.

In example embodiments, operations may be performed by one or more programmable processors 710 executing a computer program to perform functions by operating on input data and generating output. Method operations can also be performed by, and apparatus of example embodiments may be implemented as, special purpose logic circuitry (e.g., a FPGA or an ASIC).

The computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that both hardware and software architectures merit consideration. Specifically, it will be appreciated that the choice of whether to implement certain functionality in permanently configured hardware (e.g., an ASIC), in temporarily configured hardware (e.g., a combination of software and a programmable processor 710), or a combination of permanently and temporarily configured hardware may be a design choice. Below are set out hardware (e.g., machine) and software architectures that may be deployed, in various example embodiments.

### Example Machine Architecture and Machine-Readable Medium

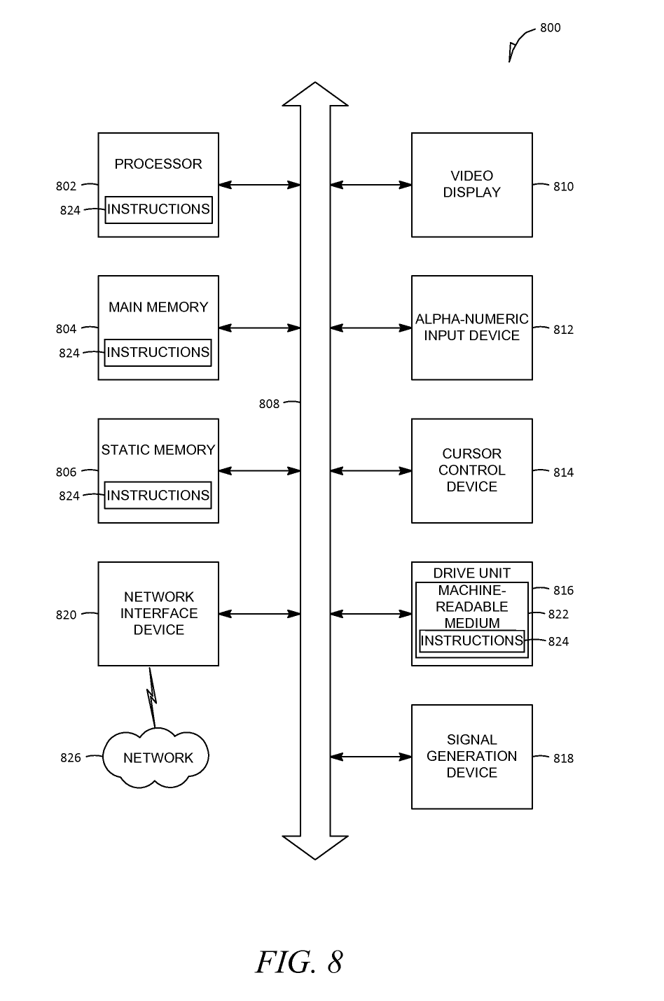

FIG. 8 is a block diagram of machine in the example form of a computer system 800 within which instructions 824 for causing the machine to perform any one or more of the methodologies discussed herein may be executed. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a PDA, a cellular telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 800 includes a processor 802 (e.g., a central processing unit (CPU), a graphics processing unit (GPU) or both), a main memory 804 and a static memory 806, which communicate with each other via a bus 808. The computer system 800 may further include a video display unit 810 (e.g., a liquid crystal display (LCD) or a cathode ray tube (CRT)). The computer system 800 also includes an alphanumeric input device 812 (e.g., a keyboard), a user interface (UI) navigation device 814 (e.g., a mouse), a disk drive unit 816, a signal generation device 818 (e.g., a speaker) and a network interface device 820.

### Machine-Readable Medium

The disk drive unit 816 includes a machine-readable medium 822 on which is stored one or more sets of data structures and instructions 824 (e.g., software) embodying or used by any one or more of the methodologies or functions described herein. The instructions 824 may also reside, completely or at least partially, within the main memory 804, static memory 806, and/or within the processor 802 during execution thereof by the computer system 800, the main memory 804 and the processor 802 also constituting machine-readable media.

While the machine-readable medium 822 is shown in an example embodiment to be a single medium, the term “machine-readable medium” may include a single medium or multiple media (e.g., a centralized or distributed database, and/or associated caches and servers) that store the one or more data structures or instructions 824. The term “machine-readable medium” shall also be taken to include any tangible medium that is capable of storing, encoding or carrying instructions for execution by the machine and that cause the machine to perform any one or more of the methodologies of the present disclosure, or that is capable of storing, encoding or carrying data structures used by or associated with such instructions. The term “machine-readable medium” shall accordingly be taken to include, but not be limited to, solid-state memories, and optical and magnetic media. Specific examples of machine-readable media 822 include non-volatile memory, including by way of example, semiconductor memory devices (e.g., erasable programmable read-only memory (EPROM), electrically erasable programmable read-only memory (EEPROM)) and flash memory devices; magnetic disks such as internal hard disks and removable disks; magneto-optical disks; and CD-ROM and DVD-ROM disks.

### Transmission Medium

The instructions 824 may further be transmitted or received over a communications network 826 using a transmission medium. The instructions 824 may be transmitted using the network interface device 820 and any one of a number of well-known transfer protocols (e.g., HTTP). Examples of communication networks include a LAN, a WAN, the Internet, mobile telephone networks, plain old telephone (POTS) networks, and wireless data networks (e.g., WiFi and WiMax networks). The term “transmission medium” shall be taken to include any intangible medium that is capable of storing, encoding or carrying instructions for execution by the machine, and includes digital or analog communications signals or other intangible media to facilitate communication of such software.

Although the embodiments of the present disclosure have been described with reference to specific example embodiments, it will be evident that various modifications and changes may be made to these embodiments without departing from the broader spirit and scope of the inventive subject matter. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be used and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

All publications, patents, and patent documents referred to in this document are incorporated by reference herein in their entirety, as though individually incorporated by reference. In the event of inconsistent usages between this document and those documents so incorporated by reference, the usage in the incorporated reference(s) should be considered supplementary to that of this document; for irreconcilable inconsistencies, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended; that is, a system, device, article, or process that includes elements in addition to those listed after such a term in a claim are still deemed to fall within the scope of that claim. Moreover, in the following claims, the terms “first,” “second,” and “third,” and so forth are used merely as labels, and are not intended to impose numerical requirements on their objects.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

What is claimed is:

1. A system comprising:
a processor of a machine;
a request module to receive a gift recommendation request identifying a gift recipient;
a data retrieval module to access coincident user data of the gift recipient from at least one social network, the coincident data describing an activity of the gift recipient and being collected as the activity is occurring; and
a determination module to determine, using the processor of the machine, at least one gift recommendation based in part on the coincident user data.

2. The system of claim 1, further comprising a communication module to communicate the one or more gift recommendations to a user.

3. The system of claim 1, wherein the determination module is to determine the at least one gift recommendation based in part on demographic information of the gift recipient.

4. The system of claim 1, wherein the coincident user data includes at least one location check-in.

5. The system of claim 1, wherein the data retrieval module is further to
identify the gift recipient as being connected to a user on the at least one social network; and
obtain social network activity of the gift recipient made available to the user based on the user and the gift recipient being connected on the at least one social network.

6. The system of claim 1, wherein the request for the gift recommendation includes an identifier of the gift recipient and wherein the data retrieval module is further to retrieve publically available social network activity of the gift recipient using the identifier of the gift recipient.

7. The system of claim 6, wherein the identifier of the gift recipient is a phone number, email address or profile identifier corresponding to a social network account of the gift recipient.

8. The system of claim 1, further comprising a filter module, in communication with the recommendation determination module, to filter the coincident user data used in determining the gift recommendation.

9. The system of claim 8, wherein the coincident user data is filtered based on the age of the gift recipient.

10. A method comprising:
receiving a gift recommendation request identifying a gift recipient;
in response to receiving the request, accessing coincident user data of the gift recipient from at least one social network, the coincident user data describing an activity of the gift recipient and being collected as the activity is occurring; and
determining, using one or more processors, at least one gift recommendation based in part on the coincident user data.

11. The method of claim 10, further comprising communicating the at least one gift recommendation to a user.

12. The method of claim 11, wherein the coincident user data includes at least one location check-in.

13. The method of claim 10, further comprising facilitating the purchase of the at least one gift recommendation.

14. The method of claim 10, wherein accessing profile data of the gift recipient comprises:
receiving login information for an account of a user on the at least one social network;
retrieving a list of social network connections of the user;
identifying the gift recipient as being connected to the user on the at least one social network;
obtaining social network activity of the gift recipient made available to the user based on the user and the gift recipient being connected on the at least one social network.

15. The method of claim 10, wherein the request for a gift recommendation includes an identifier of the gift recipient.

16. The method of claim 15, wherein accessing the profile data of the gift recipient comprises retrieving publically available coincident data of the gift recipient using the identifier of the gift recipient.

17. The method of claim 16, wherein the identifier is an email address of the gift recipient.

18. The method of claim 10, wherein determining the at least one gift recommendation includes identifying at least one keyword from the social network user data and identifying at least one item or service related to the keyword.

19. The method of claim 10, further comprising filtering the coincident data used in determining the gift recommendation based on demographic data of the gift recipient.

20. A non-transitory machine-readable storage medium embodying instructions that, when executed by a machine, cause the machine to perform operations comprising:
receiving, from a client device of a user, a gift recommendation request identifying a gift recipient;
in response to receiving the request, accessing coincident user data of the gift recipient from at least one social network, the coincident user data describing an activity of the gift recipient and being collected as the activity is occurring;
determining, using one or more processors, at least one gift recommendation based in part on the coincident user data; and
providing the at least one gift recommendation to the user.
